(19) United States
(12) Patent Application Publication
(10) Pub. No.: US 2008/0200624 A1
(43) Pub. Date: Aug. 21, 2008

(54) PROCESS FOR PREPARING POLYMERS

(76) Inventors: Virgil J. LEE, Upland, CA (US); Qiang LI, La Jolla, CA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/937,293

(22) Filed: Nov. 8, 2007

Related U.S. Application Data
(60) Provisional application No. 60/857,505, filed on Nov. 8, 2006.

(51) Int. Cl. C08F 2/06

(52) U.S. Cl. 526/90; 526/239; 526/89; 526/209; 526/210; 526/173

(57) ABSTRACT

A process for preparing polymers, e.g., conjugated polymers, illustratively by a biphasic Suzuki reaction. The process involves reacting monomers having two reactive groups selected from boronic acid, C₁-C₆ boronic acid ester, C₁-C₆ borane, and combinations thereof, with dihalide-functionalized monomers or monomers having one reactive boronic acid, boronic acid ester or borane group and one reactive halide-functional group, in a reaction mixture that contains a base, a catalytic amount of a metal complex, a phase transfer catalyst, and a two-phase solvent system including an organic solvent and an immiscible hydrophilic organic solvent.

This application claims priority under 35 USC 119(e) based upon U.S. Provisional Application No. 60/853,505, filed Nov. 8, 2006, the contents of which are incorporated herein by reference in their entirety.

### BACKGROUND

The present invention relates to processes for preparation of polymers. More specifically, the present invention is directed to a process for the preparation of polymers based upon biphasic reaction conditions, and, more particularly, a process for preparing polymers based upon new Suzuki polymerization conditions. The present invention can be used for reacting, for example, diboronic acids, diboronic acid esters, and/or diboranes with aromatic dihalides to form conjugated polymers.

The Suzuki reaction is an organic reaction of an aryl- or vinyl-boronic acid with an aryl- or vinyl-halide, catalyzed by a palladium (0) complex. It is widely used to synthesize polyolefins, styrenes and substituted biphenyls. The reaction also works with pseudohalides, such as triflates, instead of halides, and also with boron-esters instead of boronic acids.

The Suzuki reaction couples boronic acids (containing an organic part) to halides. The reaction relies on a palladium catalyst such as tetrakis(triphenylphosphine)palladium (0) to effect part of the transformation. The palladium catalyst (more strictly, a pre-catalyst) is 4-coordinate, and usually involves phosphine supporting groups.

Thus, illustratively, the present invention provides a process for preparing polymers utilizing new Suzuki polymerization conditions.

Suzuki reactions have previously been used in the preparation of polymers. Such processes involve metal-catalyzed cross-coupling reactions between aromatic diboronic acid derivatives and aromatic dihalides, in the presence of a base. Unfortunately, such reactions are only moderately effective in solvents (such as toluene) that are suitable for solubilizing the polymer. See Scherf, U., et al., Makromol. Chem., Rapid Commun., 1992, 12, 489-497, the contents of which are incorporated herein by reference in their entirety.

Higher quality polymers have been obtained using toluene/water solvent systems. See Tanigak, N., et al., Polymer 1997, 38,1221-1226, the contents of which are incorporated herein by reference in their entirety. Such higher quality polymers are achieved, in particular, when phase transfer catalysts are added to the toluene/water reaction mixtures. See U.S. Pat. No. 5,777,070 to Inbasekaran, et al., issued Jul. 7, 1998, the contents of which are incorporated herein by reference in their entirety.

U.S. Pat. No. 5,777,070 discloses a process for preparing a conjugated polymer, which includes contacting (a) monomers having two reactive groups selected from boronic acid, C₁-C₆ boronic acid ester, C₁-C₆ borane, and combinations thereof, and (b) aromatic dihalide-functional monomers or monomers having one reactive boronic acid, boronic acid ester, or borane group and one reactive halide-functional group, with each other, the monomers being selected so that the polymerization reaction products of such have conjugated unsaturated internal groups. This patent discloses that the reaction is performed in a reaction mixture which contains:

(a) an organic solvent in which the polymer forms at least a 1% solution;

(b) an aqueous solution of an inorganic base having a pKa in a range of from 9 to 13, the solution having a concentration of at least 0.1 N;

(c) a catalytic amount of a palladium complex; and

(d) at least 0.01 mol % of a phase transfer catalyst, based on the number of mols of boronic acid, boric acid ester and borane groups in the reaction mixture. This patent further discloses that the reaction is performed under conditions sufficient to form the corresponding conjugated polymer.

However, the effective temperature range of even the best procedures disclosed previously is limited. Moreover, biphasic Suzuki polymerization processes would benefit from solvent systems that facilitate the reaction work-up procedures.

### SUMMARY

The present invention relates to a process for preparing polymers, involving (a) a base, (b) a metal catalyst, (c) a phase transfer reagent, and (d) a 2-phase solvent system including (or consisting essentially of, or consisting of) an organic solvent and an immiscible hydrophilic organic solvent (such as ethylene glycol). Such process, discussed more fully in the following, uses an immiscible organic hydrophilic solvent (e.g., ethylene glycol) in place of water in biphasic Suzuki polymerization reactions, and achieves objectives as discussed in the following.

Thus, the present invention involves a process for preparing conjugated polymers using, illustratively, a biphasic (organic solvent/immiscible protic solvent) Suzuki reaction, i.e., utilizing a solvent system different from that in U.S. Pat. No. 5,777,070. That is, while U.S. Pat. No. 5,777,070 uses a mixed toluene/water solvent system, the present invention utilizes an organic solvent/immiscible protic solvent as the solvent system.

### DETAILED DESCRIPTION

Not to be limiting, the present invention can be illustrated by the following:

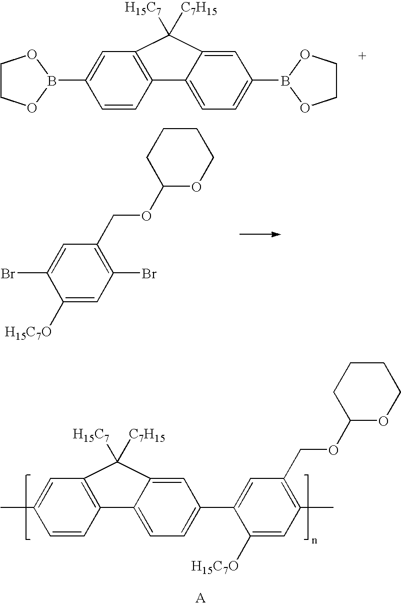

Molecular Weight of A

| | | | |
|---|---|---|---|
| Solvent System | 70° C. | 95° C. | 120° C. |
| Toluene/Water (USP 5,777,070) | 2,900 | 75,800 | Not possible |
| Toluene/Ethylene Glycol (present | 41,700 | 33,400 | 35,200* |
| invention) | | | |

*xylenes used in place of toluene

The present invention will be described further in the following. In connection therewith, as well as in connection with the description in the foregoing, it will be understood that it is not intended to limit the invention to any specific embodiments. To the contrary, it is intended to cover all alterations, modifications and equivalents as may be included within the spirit and scope of the invention as defined by the appended claims.

Throughout the present description, where compositions are described as including or comprising specific components or materials, or where processes are described as including or comprising specific steps, it is contemplated by the inventors that the compositions also consist essentially of, or consist of, the recited components or materials, or that the processes also consist essentially of, or consist of, the recited steps. Accordingly, throughout the present disclosure, any described composition can consist essentially of, or consist of, the recited components or materials, and any described process can consist essentially of, or consist of, the recited steps.

The present invention contemplates a process for producing a polymer, which includes contacting (i) monomers having two reactive groups selected from boronic acid, C₁-C₆ boronic acid ester, C₁-C₆ borane, and combinations thereof, and (ii) dihalide-functionalized monomers or monomers having one reactive boronic acid, boronic acid ester or borane group and one reactive halide-functional group, with each other and reacting these components. The reaction is performed in a reaction mixture that contains (a) an organic solvent in which the polymers form at least a 1% 4 solution; (b) a hydrophilic, immiscible organic solvent; (c) a base; (d) a catalytic amount of a metal complex; and (e) at least 0.01 mole % of a phase transfer catalyst, based on the number of moles of boronic acid, boronic acid ester, and borane groups in the reaction mixture. The reaction is performed under reaction conditions sufficient to form the corresponding polymer.

The present invention includes additional features as discussed in the following. Thus, according to the present invention, the molar ratio of monomers having two reactive groups selected from boronic acid, C₁-C₆ boronic acid ester, C₁-C₆ borane, and combinations thereof, to aromatic dihalide-functional monomers can be at least 1.02:1.00.

As further features, the organic solvent can be a C₆-C₂₀ aromatic group-containing compound, and the metal complex can be a palladium or nickel complex. Illustratively, the organic solvent can be benzene, toluene, xylene, xylenes, ethylbenzene, mesitylene or anisole; and the hydrophilic, immiscible organic solvent can be, e.g., ethylene glycol or propylene glycol.

The base can be an alkali metal carbonate, alkali metal bicarbonate or a mixture thereof, e.g., can be sodium bicarbonate or potassium carbonate; and the base can be employed in an amount sufficient to provide a molar ratio of base to halide-functional monomer of at least 2:1.

The metal complex can be employed in an amount sufficient to provide a molar ratio of metal to monomer in a range of from 0.001:1-0.05:1. The phase transfer catalyst can be C₄-C₃₀ tetraalkylammonium halide; and the phase transfer catalyst can be employed in an amount sufficient to provide a molar ratio of catalyst to monomer of at least 0.01:1.

Desirably, the polymer reaches a degree of polymerization of at least 20 in less than 24 hours. As an illustration of the present invention, and not to be limiting, the polymer can contain at least 20 repeat units of the following formula:

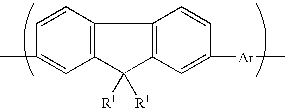

wherein Ar is a conjugated unsaturated group; and R¹ is independently in each occurrence C₁-C₂₀ hydrocarbyl or C₁-C₂₀ hydrocarbyl containing one or more S, N, O, P, or Si atoms, C₄-C₁₆ hydrocarbyl carbonyloxy, C₄-C₁₆ aryl (trialkylsiloxy) or both, R¹ may form, with the 9-carbon on the fluorene ring, a C₅-C₂₀ ring structure or a C₄-C₂₀ ring structure containing one or more heteroatoms of S, N. or O. Illustratively, Ar of this polymer can be 1,4-phenylene or a substituted 1,4-phenylene, or can be benzothiadiazole.

According to the process of the present invention, the polymer can be a wholly or partially conjugated polymer. Illustratively, the polymer can contain segments of at least two 1,4-phenylene units or two substituted 1,4-phenylene units.

The presently described process, for the preparation of polymers, allows for milder reaction conditions than current methods. This presently described process allows for higher quality polymers to be prepared, at lower temperatures. The process also enables higher temperatures to be used in mixed-phase Suzuki polymerization reactions (at constant pressures). For example, a high quality poly(fluorene-phenylene) polymer can be prepared from polymerization of bis-boronic acid derivatives with aryl dibromide at 120° C. Comparable reactions with aqueous biphasic mixtures are not possible, because water boils at 100° C. at atmospheric pressure.

The present invention also offers other advantages over current procedures for preparing polymers. For example, the all-organic solvent system according to the present invention enables more facile work-up procedures relative to comparable organic-aqueous biphasic solvent systems. Additionally, the present procedure allows for more versatility in catalysts and reagents than are used currently in Suzuki processes.

The following Example and Comparative Example, set forth in Table 1, illustrating advantages of the present invention, are illustrative in the present invention and are not limiting. Table 1 shows polymerization of bis-boronic acid derivatives 1 with aryl dibromide 2 to give the poly(fluorene-phenylene) polymer 3. With both the boronic acid 1a and the boronic ester monomer 1b, much higher molecular weights of polymer 3 are obtained in a toluene/ethylene glycol (1/1) versus a toluene/water (1/1) solvent system at 70° C., while comparable results are obtained at 95° C. (Table 1). Thus, the present invention allows for higher quality polymers to be prepared at lower temperatures. Table 1 also shows that a high quality poly(fluorene-phenylene) polymer 3 can be prepared from polymerization of bis-boronic acid derivatives 1 with aryl dibromide 2 at 120° C.

As seen in the Example and Comparative Example, the present invention allows for milder reaction conditions than current methods, and achieves much higher molecular weights at 70° C. (that is, lower temperatures). Moreover, as can be seen in the results in Table 1 at 120° C., the present invention can be used at higher temperatures.

TABLE 1
Suzuki Polymerization Results Demonstrating the Molecular Weight
Advantages of a Solvent System Based on Toluene/Ethylene Glycol vs.
Toluene/Water

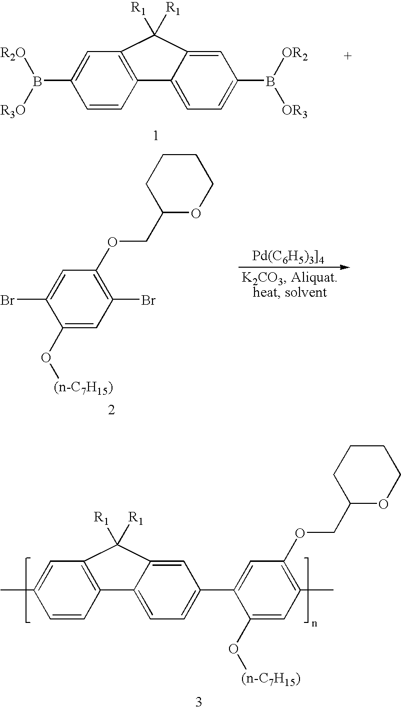

a: R₁ = n-C₆H₁₃: R₂ = R₃ = H
b: R₁ = n-C₇H₁₅; R₂ = R₃ = —CH₂CH₂—

| | | Weight Ave. Molecular Weight | |
|---|---|---|---|
| | | (polydispersity) | |
| | | solvent = | solvent = |
| Boronic Acid | Reaction | toluene/water | toluene/ethylene glycol* |
| Derivative | Temp. (° C.) | (1/1) | (1/1) |
| 1a | 70 | 1070 (2.2) | 36,200 (1.8) |
| 1a | 95 | 30,600 (1.8) | 30,600 (1.8) |
| 1a | 120 | n/a | 42,500 (1.8)* |
| 1b | 70 | 7,400 (2.8) | 34,600 (1.7) |
| 1b | 95 | 33,300 (2.1) | 35,100 (1.8) |
| 1b | 120 | n/a | 39,700 (2.0)* |

*Xylenes was used in place of toluene in the reactions performed at 120° C.

What is claimed is:

1. A process for preparing a polymer, which comprises contacting (i) monomers having two reactive groups selected from the group consisting of boronic acid, C₁-C₆ boronic acid ester, C₁-C₆ borane, and combinations thereof, and (ii) dihalide-functionalized monomers or monomers having one reactive boronic acid, boronic acid ester, or borane group and one reactive halide-functional group, with each other, in a reaction mixture that includes:
(a) an organic solvent in which the polymer forms at least a 1 percent solution;
(b) a hydrophilic, immiscible organic solvent;
(c) a base;
(d) a catalytic amount of a metal complex; and
(e) at least 0.01 mole percent of a phase transfer catalyst, based on the number of moles of boronic acid, boronic acid ester, and borane groups in the reaction mixture,
under reaction conditions sufficient to form the corresponding polymer.

2. The process of claim 1, wherein the molar ratio of (i) monomers having two groups selected from the group consisting of boronic acid, C₁-C₆ boronic acid ester, C₁-C₆ borane, and combinations thereof, to aromatic dihalide-functional monomers is at least 1.02:1.00.

3. The process of claim 1, wherein the organic solvent is a C₆-C₂₀ aromatic group-containing compound.

4. The process of claim 1, wherein the metal complex is a palladium or nickel complex.

5. The process of claim 1, wherein the organic solvent is benzene, toluene, xylene, xylenes, ethylbenzene, mesitylene, or anisole.

6. The process of claim 1, wherein the hydrophilic, immiscible organic solvent is ethylene glycol or propylene glycol.

7. The process of claim 1, wherein the base is an alkali metal carbonate, alkali metal bicarbonate, or a mixture thereof.

8. The process of claim 1, wherein the base is sodium carbonate or potassium carbonate.

9. The process of claim 7, wherein the base is employed in an amount sufficient to provide a molar ratio of base to halide-functional monomer of at least 2:1.

10. The process of claim 1, wherein the metal complex is employed in an amount sufficient to provide a molar ratio of metal to monomer in the range of from 0.001:1 to 0.05:1.

11. The process of claim 1, wherein the phase transfer catalyst is C₄-C₃₀ tetraalkylammonium halide.

12. The process of claim 1, wherein the phase transfer catalyst is employed in an amount sufficient to provide a molar ratio of catalyst to monomer of at least 0.01:1.

13. The process of claim 1, wherein the polymer reaches a degree of polymerization of at least 20 in less than 24 hours.

14. The process of claim 1, wherein the polymer contains at least 20 repeat units of the formula: 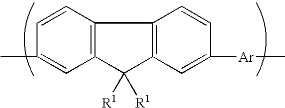
wherein Ar is a conjugated unsaturated group; and R¹ is independently in each occurrence C₁-C₂₀ hydrocarbyl or C₁-C₂₀ hydrocarbyl containing one or more S, N, O, P, or Si atoms, C₄-C₁₆ hydrocarbyl carbonyloxy, C₄-C₁₆ aryl (trialkylsiloxy) or both, R¹ may form, with the 9-carbon on the fluorene ring, a C₅-C₂₀ ring structure or a C₄-C₂₀ ring structure containing one or more heteroatoms of S, N, or O.

15. The process of claim 14, wherein Ar is 1,4-phenylene or a substituted 1,4-phenylene.

16. The process of claim 14, wherein Ar is benzothiadiazole.

17. The process of claim 1, wherein the polymer is a wholly or partially conjugated polymer.

18. The process of claim 1, wherein the polymer contains segments of at least two 1,4-phenylene units or two substituted 1,4-phenylene units.
